(19) United States
(12) Patent Application Publication
(10) Pub. No.: US 2012/0028059 A1
(43) Pub. Date: Feb. 2, 2012

(54) COMPOSITE BONDED LEATHER MATERIAL

(76) Inventor: Peter Barretto, Gormley (CA)

(21) Appl. No.: 13/145,691

(22) PCT Filed: Jan. 21, 2010
(86) PCT No.: PCT/CA2010/000084

§ 371 Date: Oct. 6, 2011

Related U.S. Application Data
(60) Provisional application No. 61/202,017, filed on Jan. 21, 2009.

(51) Int. Cl. B32B 9/02; B32B 3/00

(52) U.S. Cl. 428/473; 428/337; 428/332

(57) ABSTRACT

Provided is a composite bonded leather material. The material may be used as flooring, for wall applications or for ceiling applications. A leather layer is bonded to a substrate layer using adhesive. The substrate layer may be agglomerated cork or wood fiber. The leather layer may be textured or may be prefinished.

### FIELD OF THE INVENTION

The present invention relates to composite materials and in particular to a bonded leather composite material for interior commercial and residential wall, floor and ceiling applications.

### BACKGROUND OF THE INVENTION

Natural leather floors have been known and used for some time. The raw material supply necessary for manufacturing natural leather floors can be very limited. The manufacture and installation of natural leather floors can also be very specialized and thus also not easily available.

One drawback of natural leather floors is that they scuff and mark easily and are therefore extremely difficult to maintain in relation to other known floors such as laminate or hardwood. Further, natural leather floors are one of the most expensive floors on the market.

Natural leather floors are therefore restricted to a minute sub-section of the market. Many consumers may not even know that natural leather floors exist.

Bonded leather is a product known in the art since at least the early 1900s when it was produced in Europe. It comes from the process of using post-industrial scrap natural leather and grinding it down to fibre state. The fibres are then bonded back together with natural latex and various chemicals to form a bonded leather rolled good. The rolled goods are either sold as is or are coloured or textured to be sold into various original equipment manufacturer applications. The scrap natural leather may come from various tanneries, leather shoe/furniture/giftware/clothing manufacturers as well from the left over leather from the automotive industry. Bonded leather was predominately used in the footwear industry and has recently evolved into the giftware, furniture and clothing industries. Bonded leather has recently been used in various architectural applications and most recently in glue-down site-finished flooring.

A limited amount of relatively costly bonded leather flooring has been sold on the market over the past few years. However, these bonded floors has had limited commercial success due to the problems discussed below.

The bonded leather flooring was not stable which caused the floor to cup, curl and shrink. It is difficult to find proper adhesives to prevent these issues and to prevent the lifting of the adhered tile to the sub-floor. Further, costly sub-floor preparation is required to make the sub-floor surfaces suitable for bonded leather flooring tile to adhere and not peak around the edges.

Hydrostatic pressure found in most concrete sub-floors makes glue down tiles very problematic in that they may blow off the floor.

The vast majority of job site failures from current bonded leather flooring come from improper installation. Finding and then paying for the professional installer required is also very difficult to impossible in some areas. Sales can be very restricted due to this fact.

Bonded leather floors are only partially finished and must have the final finish applied on site, creating a multitude of problems. Getting an experienced finisher, having the right finish, having it finished properly, having the right site conditions for the finish to cure properly, having the site protected from airborne dust and dirt that can contaminate the finish are just some of the challenges.

If a bonded leather floor fails it can be extremely costly to repair and can cause anywhere from two to five time the material cost in liability due to the costly removal or disposal of the faulty material, additional sub-floor preparation required, cost of replacement material, and new installation costs plus a wide variety of additional incidental costs that arise from not being able to utilize the site for upwards of a week.

Prefinish technology (i.e. prefinishing floors in the factory or before installation) has been introduced in hardwood flooring over the past three decades. The vast majority of floors sold in the world are prefinished rendering site finish as a niche specialty business.

Overall, the sales of bonded leather flooring have been curtailed due to the costs, hassles and high product liability associated with the gluing down and site finishing of bonded leather floors.

The expense associated with tying up the site to glue down and then finish the product on site is significant and substantially raise costs. The time required may prevents the product from being specified in the first place.

The current bonded leather wall products being sold on the market have the following problems: difficulties installing rolled goods for wall applications; challenges in getting specialized installers and high costs associated with professional installation; stability challenges of the bonded leather that cause it to shrink or peel off the wall; and, difficulties finding proper adhesives to prevent these issues and if found, difficulties to get installers to follow the instructions to install property.

There is currently no bonded leather ceiling tile being sold on the market.

The invention disclosed herein addresses at least one of the above problems.

### SUMMARY

One aspect of the composite bonded leather flooring application is a composite material, comprising a substrate layer; and a leather layer having a lower surface opposite an upper surface, the lower surface fixed to the substrate layer by an adhesive.

The material may be used for wall, ceiling or floor applications. In one aspect the leather layer may have a finish applied to its surface.

In another aspect the substrate layer is agglomerated cork (high density, medium to low density or low density).

In another aspect the substrate layer is wood fiber (medium to low density or low density).

### BRIEF DESCRIPTION OF THE DRAWINGS

In order that the subject matter may be readily understood, embodiments are illustrated by way of examples in the accompanying drawings, in which:

FIG. 1 shows a cross-section of one embodiment of the composite material showing the multiple layers of the bonded leather with a cork substrate without a finished topcoat;

FIG. 2 shows a cross-section of another embodiment of the composite material showing the multiple layers of the bonded leather with a wood fiber substrate without a finished topcoat;

FIG. 3 shows a cross-section corresponding to FIG. 1 but with a factory finish; and

FIG. 4 shows a cross-section corresponding to FIG. 1 but with a finished topcoat.

### DETAILED DESCRIPTION

Disclosed is a composite bonded leather material for interior commercial and residential wall, floor, and ceiling applications. This invention uses pre-colored textured bonded leather as the surface material fused together with a substrate of agglomerated cork or wood fiber. It can be prefinished or site finished depending on end user requirements. Agglomerated cork has the advantage of being a natural insulator for heat and sound.

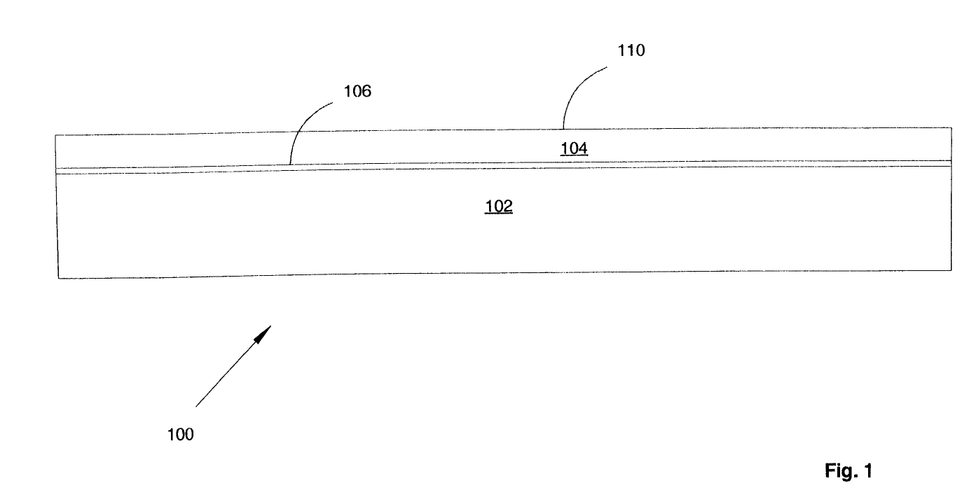

FIG. 1 shows a cross-section of one embodiment of the composite bonded leather material generally indicated by reference 100. An adhesive 106 binds a cork substrate 102 to a bonded leather layer 104. The adhesive 106 is preferably water based with no volatile organic compounds. In this embodiment the bonded leather layer 104 is of high density bonded leather in thickness from 0.3 m to 1 mm.

The leather layer 104 may have an embossed textured surface 110, which can be created either via embossing rollers or plates as is known in the art. The textured surface 10 may be painted with a multi-coat system from 1 to 6 coats, with fade resistant, non-toxic coatings.

The adhesive 106 may be a non-VOC adhesive for securely bonding the leather 104 to the substrate 102 to prevent any movement or delamination. Special time requirements to stabilize the composite bonded leather material 100 after bonding may be required.

The cork substrate 102 may be agglomerated cork. The agglomerated cork 102 may be high density (e.g. for flooring applications), low to medium density (e.g. for wall applications) or low density (e.g. for ceiling applications).

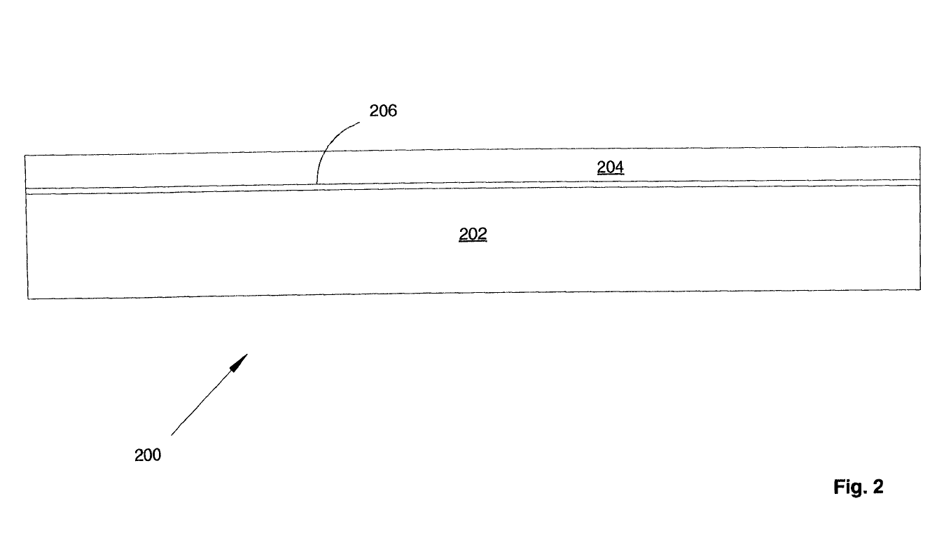

FIG. 2 shows a cross-section of another embodiment of the composite bonded leather material generally indicated by reference 200. An adhesive 206 binds a wood substrate 202 to a bonded leather layer 204. The wood substrate 202 may be a wood fiber for example. The wood 202 may be a high density wood fiber. Alternatively, the wood 202 may be a low density wood fiber.

The wood fiber substrate 202 may be low to medium density (e.g. for wall applications) or low density (e.g. for ceiling applications).

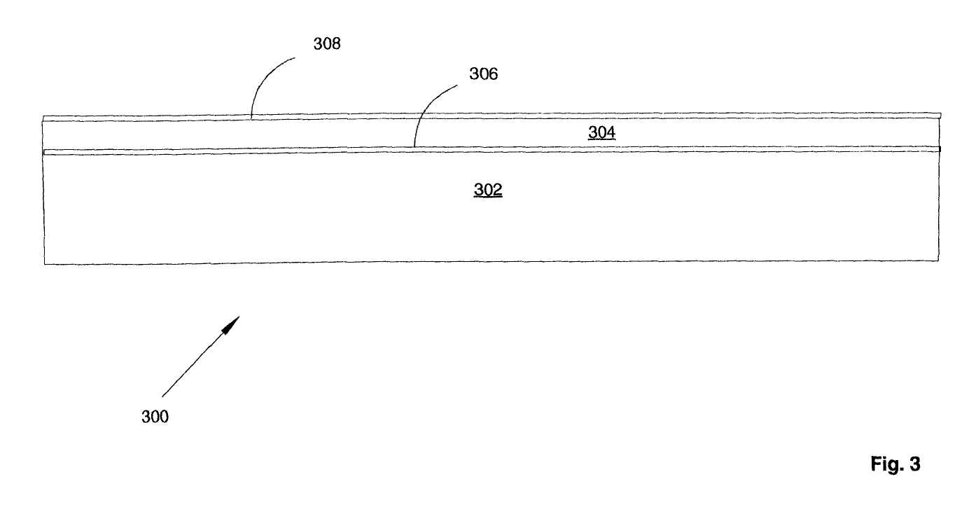

FIG. 3 shows a cross-section of another embodiment of the composite bonded leather material generally indicated by reference 300. An adhesive 306 binds a cork substrate 302 to a bonded leather layer 304. A finish 308 is applied to the bonded leather layer 304.

The finish 308 may optionally be a nano-technology finish in which 3 to 5 coats of water based wear resistant finish are applied. The cork substrate 302 may be high density agglomerated cork for example.

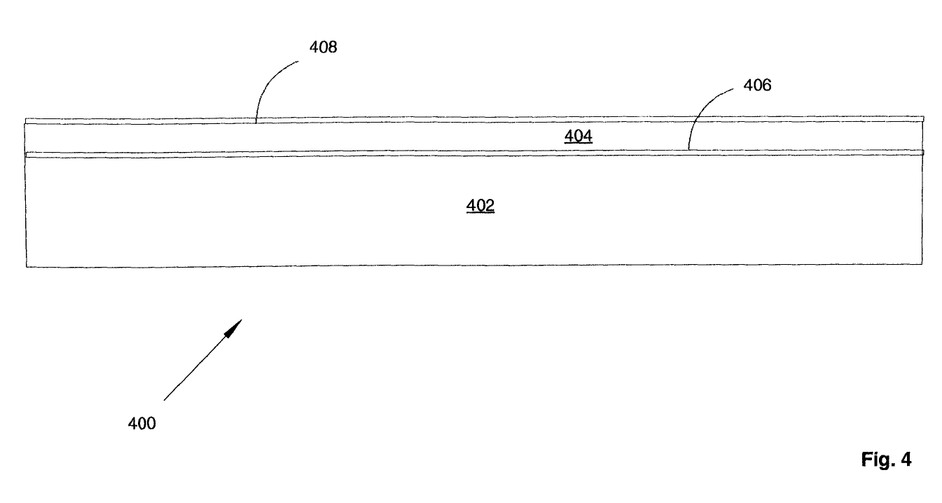

FIG. 4 shows a cross-section of yet another embodiment of the composite bonded leather material generally indicated by reference 400. An adhesive 406 binds a wood substrate 402 to a bonded leather layer 404. A finish 408 is applied to the bonded leather layer 404. The wood substrate 402 may be a wood fiber for example. The wood 402 may be a high density wood fiber. Alternatively, the wood 402 may be a low density wood fiber.

The finish 408 may, for example, be a nano-technology finish in which 3 to 5 coats of water based wear resistant finish are applied. The wood fiber substrate 402 may be a low to medium density wood fiber (e.g. for wall applications) or low density wood fiber (e.g. for ceiling applications)

The bonded leather layer 104, 204, 304, 404 is preferably between 0.3 mm and 1 mm thick. It can be pre-colored and pre-textured before adhesion to the substrate 102, 202, 302, 402.

The composite bonded leather material 100, 200, 300, 400 may be used as is for wall, floor or ceiling products. Alternatively, the composite bonded leather material can be used as the top layer for an engineered wall, floor or ceiling product. For example, the composite bonded leather material 100, 200, 300, 400 may be installed as a glue down floor or, alternatively, it may be installed as part of a tiled floor.

The finish 308, 408 may be applied by the homeowner or during manufacture of the composite material 300, 400.

The cork substrate 102, 302 may be high density cork with a thickness of between 2 mm to 6 mm for a floor application. The cork substrate 102, 302 may be a medium to low density for wall applications with a thickness of 2 mm to 8 mm. For ceiling applications, the cork substrate 102, 302 may be a low density cork with a thickness of 12 mm to 25 mm.

The wood fiber substrate 202, 402 may be low density wood fiber for wall applications with a thickness of 6 mm to 25 mm. For ceiling applications the wood fiber substrate may be of low density with a thickness of 14 mm to 25 mm.

The composite leather material 100, 200, 300, 400 can be easily installed either as a finished product (e.g. for a wall, ceiling or floor) or as a component product. Further, the composite leather material 100, 200, 300, 400 does not need costly specialized installers or specialized site finishers. The material can be installed by an inexperienced homeowner for example.

The bonded leather 104, 204, 304, 404 may be attained in large commercial rolls. The leather 104, 204, 304, 404 can be in a thickness of between 0.3 mm to 1 mm and may be textured and colored at the bonded leather factory for example.

The high-density agglomerated cork may be manufactured in large commercial rolls at a cork factory, which a thickness ranging from 2 mm to 8 mm. The low to medium density agglomerated cork (e.g. 102, 302) may also be manufactured in large commercial sheets at a cork factory ranging from 6 mm to 25 mm thick. The low to medium density wood fiber (e.g. 202, 402) panels would be made in large sheets at a wood fiber factory in thicknesses ranging from 6 mm to 25 mm.

The example composite bonded leather materials provided above may be pressed at different pressure levels and for different timelines based on the densities of the different substrates (as is known in the art).

The composite bonded leather material described herein may be stored or sold in sheets in rolls if the material is as thin as 2 mm. Alternatively the bonded leather material may be stored or sold in planks or tiles.

What is claimed is:

1. A composite material, comprising:
a substrate layer; and
a leather layer having a lower surface opposite an upper surface, the lower surface fixed to the substrate layer by an adhesive.

2. The material of claim 1 the substrate layer comprising wood fiber.

3. The material of claim 1 the substrate layer comprising agglomerated cork.

4. The material of claim 1 the leather layer comprising bonded leather.

5. The material of claim 1 further comprising a finish, the finish applied to the upper surface of the leather layer.

6. The material of claim 4 the leather layer having a thickness of between 0.3 mm and 1 mm.

7. The material of claim 3, the agglomerated cork comprising high density agglomerated cork and having a thickness of between 2 mm and 6 mm, wherein the agglomerated cork is used for floor applications.

8. The material of claim 3, the agglomerated cork comprising medium to low density agglomerated cork and having a thickness of between 2 mm and 8 mm, wherein the agglomerated cork is used for wall applications.

9. The material of claim 3, the agglomerated cork comprising low density agglomerated cork and having a thickness of between 12 mm and 25 mm, wherein the agglomerated cork is used for ceiling applications.

10. The material of claim 2, the wood fiber comprising medium to low density wood fiber and having a thickness of between 6 mm and 25 mm, wherein the wood fiber is used for wall applications.

11. The material of claim 2, the wood fiber comprising low density wood fiber having a thickness of between 14 mm and 25 mm, wherein the wood fiber is used for ceiling applications.

12. Use of the material defined in claim 1 for covering floors.

13. Use of the material defined in claim 1 for covering walls.

14. Use of the material defined in claim 1 for covering ceilings.

15. The material of claim 1 wherein the material is cut into tiles for covering surfaces.

16. The material of claim 10 wherein the surfaces comprise floors.

17. The material of claim 10 wherein the surfaces comprise walls.

18. The material of claim 10 wherein the surfaces comprising ceilings.
